(19) United States
(12) Patent Application Publication
(10) Pub. No.: US 2015/0295504 A1
(43) Pub. Date: Oct. 15, 2015

(54) ELECTRIC POWER CONVERSION APPARATUS AND METHOD OF CONTROLLING THE SAME

(71) Applicant: TOYOTA JIDOSHA KABUSHIKI KAISHA, Toyota-shi (JP)

(72) Inventors: Fumiki TANAHASHI, Miyoshi-shi (JP); Shoichi SHONO, Miyoshi-shi (JP); Masafumi UCHIHARA, Toyota-shi (JP); Naoto HASEGAWA, Seto-shi (JP); Mitsuhiro MIURA, Toyota-shi (JP)

(21) Appl. No.: 14/678,160

(22) Filed: Apr. 3, 2015

(30) Foreign Application Priority Data
Apr. 10, 2014 (JP) 2014-081404

(51) Int. Cl. H02M 3/335; H02J 7/00

(52) U.S. Cl. CPC H02M 3/33584; H02J 7/0065

(57) ABSTRACT

An electric power conversion apparatus includes a transformer having a primary coil and a secondary coil; a primary-side full bridge circuit having first and second arm circuits in parallel, respective midpoints of the first and second arm circuits being connected via the primary coil; a secondary-side full bridge circuit having third and fourth arm circuits in parallel, respective midpoints of the third and fourth arm circuits being connected via the secondary coil. The number of turns of the secondary coil between the latter respective midpoints is switched and transmission power transmitted between the primary-side and the secondary-side full bridge circuits is controlled through adjustment of a phase difference in switching between the first arm circuit and the third arm circuit and a phase difference in switching between the second arm circuit and the fourth arm circuit.

### BACKGROUND OF THE INVENTION

1. Field of the Invention

The present invention relates to a technique of converting electric power between a primary-side full bridge circuit and a secondary-side full bridge circuit.

2. Description of the Related Art

In the related art, an electric power conversion apparatus that converts electric power between a primary-side full bridge circuit and a secondary-side full bridge circuit is known (for example, see Japanese Laid-Open Patent Application No. 2011-193713).

### SUMMARY OF THE INVENTION

According to one idea, an electric power conversion apparatus includes a transformer having a primary coil and a secondary coil; a primary-side full bridge circuit having a first arm circuit and a second arm circuit in parallel, wherein a first midpoint of the first arm circuit and a second midpoint of the second arm circuit are connected via a winding of the primary coil; a secondary-side full bridge circuit having a third arm circuit and a fourth arm circuit in parallel, wherein a third midpoint of the third arm circuit and a fourth midpoint of the fourth arm circuit are connected via the winding of the secondary coil; a switching circuit configured to switch a number of turns of the winding of the secondary coil between the third midpoint and the fourth midpoint; and a control part configured to control transmission power transmitted between the primary-side full bridge circuit and the secondary-side full bridge circuit by adjusting a first phase difference between switching in the first arm circuit and switching in the third arm circuit and a second phase difference between switching in the second arm circuit and switching in the fourth arm circuit.

Other objects, features and advantages of the present invention will become more apparent from the following detailed description when read in conjunction with the accompanying drawings.

### BRIEF DESCRIPTION OF THE DRAWINGS

FIG. 1 illustrates one example of a configuration of an electric power conversion apparatus;

FIG. 2 is a block diagram illustrating one example of a configuration of a control part;

FIG. 3 is a timing chart illustrating one example of normal control except switching the number of turns;

FIG. 4 illustrates one example of relations between transmission power, efficiency, and a voltage of a secondary-side full bridge circuit;

FIG. 5 illustrates one example of relations between transmission power, efficiency, and a voltage of a secondary-side full bridge circuit and numbers of turns;

FIG. 6 is a flowchart illustrating one example of a method of switching the number of turns;

FIG. 7 is a flowchart illustrating one example of a method controlling each full bridge circuit when switching the number of turns;

FIG. 8 is a timing chart illustrating one example of switching the number of turns;

FIG. 9 illustrates another example of a configuration of an electric power conversion apparatus;

FIG. 10 illustrates yet another example of a configuration of an electric power conversion apparatus; and

FIG. 11 illustrates yet another example of a configuration of an electric power conversion apparatus.

### DETAILED DESCRIPTION OF THE EMBODIMENTS

Below, using the accompanying drawings, embodiments of the present invention will be described.

In the related art described above, it may be difficult to transmit target electric power between a primary-side full bridge circuit and a secondary-side full bridge circuit depending on a voltage ratio between the primary side and the secondary side in the respective parts. For example, when a voltage of a battery connected to the secondary-side full bridge circuit falls excessively, it may be impossible to transmit required electric power between the primary-side full bridge circuit and the secondary-side full bridge circuit.

Therefore, an object of the embodiments is to provide an electric power conversion apparatus and a method of controlling the same by which it is possible to transmit sufficient electric power between a primary-side full bridge circuit and a secondary-side full bridge circuit even when the voltage ratio between respective portions of the primary side and the secondary side varies.

### <Configuration of Power Supply Apparatus 101>

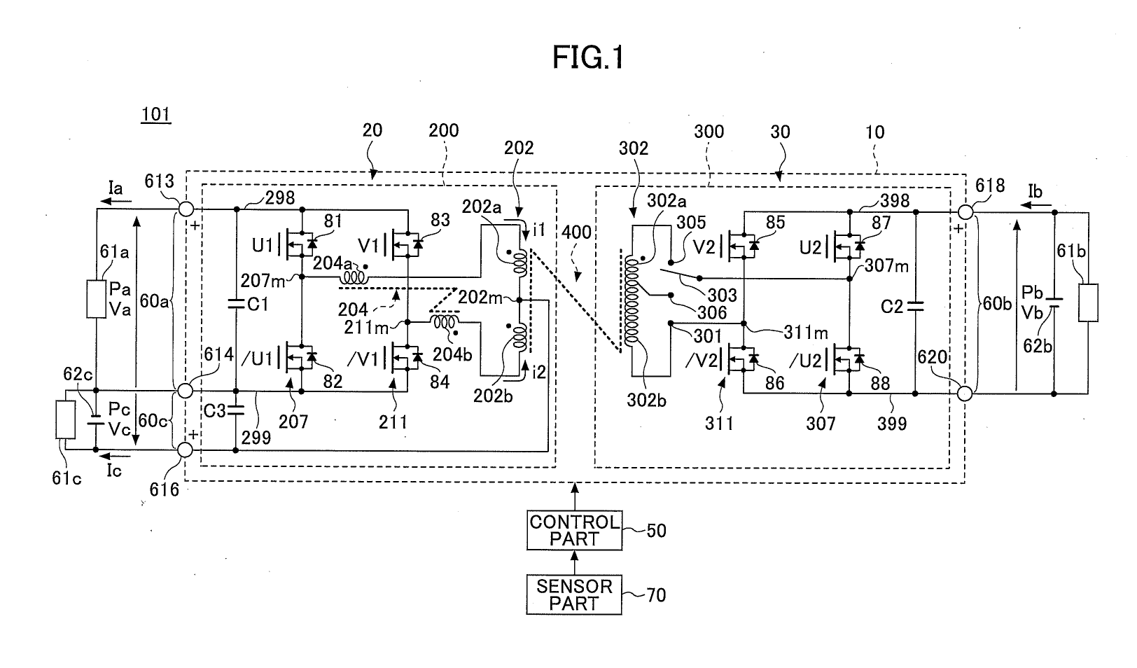

FIG. 1 is a block diagram illustrating a configuration example of a power supply apparatus 101 according to one embodiment of an electric power conversion apparatus. The power supply apparatus 101 is, for example, a power supply system including a power supply circuit 10, a control part 50 and a sensor part 70. The power supply apparatus 101 is, for example, a system mounted in a vehicle such as an automobile and distributes electric power to respective loads mounted in the vehicle. As a specific example of such a vehicle, a hybrid car, a plug-in hybrid car, an electric car or the like can be cited. The power supply apparatus 101 can also be mounted in a vehicle that is driven mainly by an internal-combustion engine.

The power supply apparatus 101 includes, for example, a first input/output port 60a to which a primary-side high-voltage-system load 61a is connected and a second input/output port 60c to which a primary-side low-voltage-system load 61c and an auxiliary battery 62c are connected, as primary-side ports. The auxiliary battery 62c is one example of a primary-side low-voltage-system power source that supplies electric power to the primary-side low-voltage-system load 61c driven by the same voltage system (for example, a 12 V system) as the auxiliary battery 62c. The auxiliary battery 62c also supplies electric power, boosted by a primary-side conversion circuit 20 included in the power supply circuit 10, to, for example, the primary-side high-voltage-system load 61a driven by a voltage system (for example, a 48 V system higher in voltage than the 12 V system) different from the auxiliary battery 62c. As a specific example of the auxiliary battery 62c, a secondary battery such as a lead battery can be cited.

The power supply apparatus 101 also has, for example, a third input/output port 60b to which a secondary-side high-voltage-system load 61b and a main battery (i.e., a propulsion battery or a traction battery) 62b are connected as a secondary-side port. The main battery 62b is one example of a secondary-side high-voltage-system power source that supplies electric power to the secondary-side high-voltage-system load 61b driven by the same voltage system (for example, a 288 V system higher in voltage than the 12 V system and the 48 V system) as the main battery 62b. As a specific example of the main battery 62b, a secondary battery such as a lithium-ion battery can be cited.

The power supply circuit 10 has the above-mentioned three input/output ports, and any two input/output ports are selected from among the three input/output ports. The power supply circuit 10 is an electric power conversion apparatus that carries out electric power conversion between the thus selected two input/output ports. Note that the power supply apparatus 101 including the power supply circuit 10 can be an apparatus having three or more input/output ports, and being able to convert electric power between any two of these input/output ports.

Port power Pa, Pc and Pb denote input/output power (i.e., input power or output power) to/from the first input/output port 60a, the second input/output port 60c and the third input/output port 60b, respectively. Port voltages Va, Vc and Vb denote input/output voltages (i.e., input voltages or output voltages) at the first input/output port 60a, the second input/output port 60c and the third input/output port 60b, respectively. Port currents Ia, Ic and Ib denote input/output currents (i.e., input currents or output currents) to/from the first input/output port 60a, the second input/output port 60c and the third input/output port 60b, respectively.

The power supply circuit 10 includes a capacitor C1 connected with the first input/output port 60a, a capacitor C3 connected with the second input/output port 60c and a capacitor C2 connected with the third input/output port 60b. As specific examples of the capacitors C1, C2 and C3, film capacitors, aluminum electrolytic capacitors, ceramic capacitors, solid polymer capacitors or the like can be cited.

The capacitor C1 is inserted between a high-potential-side terminal 613 of the first input/output port 60a and a low-potential-side terminal 614 of the first input/output port 60a and the second input/output port 60c. The capacitor C3 is inserted between a high-potential-side terminal 616 of the second input/output port 60c and the low-potential-side terminal 614 of the first input/output port 60a and the second input/output port 60c. The capacitor C2 is inserted between a high-potential-side terminal 618 of the third input/output port 60b and a low-potential-side terminal 620 of the third input/output port 60b.

The capacitors C1, C2 and C3 can be installed inside the power supply circuit 10 or outside the power supply circuit 10.

The power supply circuit 10 is an electric power conversion circuit including the primary-side conversion circuit 20 and the secondary-side conversion circuit 30. Note that the primary-side conversion circuit 20 and the secondary-side conversion circuit 30 are connected via primary-side magnetic coupling reactors 204, and also, are magnetically coupled by a transformer 400. The primary-side ports including the first input/output port 60a and the second input/output port 60c and the secondary-side port including the third input/output port 60b are connected via the transformer 400.

The primary-side conversion circuit 20 is a primary-side circuit including a primary-side full bridge circuit 200, the first input/output port 60a and the second input/output port 60c. The primary-side full bridge circuit 200 is provided at the primary side of the transformer 400. The primary-side full bridge circuit 200 is a primary-side power conversion part including a primary coil 202 of the transformer 400, the primary-side magnetic coupling reactors 204, a primary-side first upper arm U1, a primary-side first lower arm /U1, a primary-side second upper arm V1 and a primary-side second lower arm /V1. The primary-side first upper arm U1, the primary-side first lower arm /U1, the primary-side second upper arm V1 and the primary-side second lower arm /V1 are, for example, switching devices including N-channel MOSFETs and body diodes (i.e., parasitic diodes) that are parasitic elements of the MOSFETs, respectively. Diodes can be additionally connected to the MOSFETs in parallel. FIG. 1 illustrates the diodes 81, 82, 83 and 84.

The primary-side full bridge circuit 200 includes a primary-side positive bus 298 connected with the high-potential-side terminal 613 of the first input/output port 60a and a primary-side negative bus 299 connected with the low-potential-side terminal 614 of the first input/output port 60a and the second input/output port 60c.

Between the primary-side positive bus 298 and the primary-side negative bus 299, a primary-side first arm circuit 207 is connected where the primary-side first upper arm U1 and the primary-side first lower arm /U1 are connected in series. The primary-side first arm circuit 207 is a primary-side first power conversion circuit part capable of carrying out a power conversion operation through turning-on/off switching operations of the primary-side first upper arm U1 and the primary-side first lower arm /U1 (i.e., a primary-side U-phase power conversion circuit part). Also, between the primary-side positive bus 298 and the primary-side negative bus 299, a primary-side second arm circuit 211 is connected where the primary-side second upper arm V1 and the primary-side second lower arm /V1 are connected in series, parallel to the primary-side first arm circuit 207. The primary-side second arm circuit 211 is a primary-side second power conversion circuit part capable of carrying out a power conversion operation through turning-on/off switching operations of the primary-side second upper arm V1 and the primary-side second lower arm /V1 (i.e., a primary-side V-phase power conversion circuit part).

In a bridge part connecting the midpoint 207m of the primary-side first arm circuit 207 and the midpoint 211m of the primary-side second arm circuit 211, the primary coil 202 and the primary-side magnetic coupling reactors 204 are provided. In more detail of connection relationship in the bridge part, one end of a primary-side first reactor 204a of the primary-side magnetic coupling reactors 204 is connected to the midpoint 207m of the primary-side first arm circuit 207. To the other end of the primary-side first reactor 204a, one end of the primary coil 202 is connected. Also, to the other end of the primary coil 202, one end of a primary-side second reactor 204b of the primary-side magnetic coupling reactors 204 is connected. Further, the other end of the primary-side second reactor 204b is connected to the midpoint 211m of the primary-side second arm circuit 211. Note that the primary-side magnetic coupling reactors 204 include the primary-side first reactor 204a and the primary-side second reactor 204b that is magnetically connected to the primary-side first reactor 204a with a coupling coefficient k₁.

The midpoint 207m is a primary-side first mid node between the primary-side first upper arm U1 and the primary-side first lower arm /U1. The midpoint 211m is a primary-side second mid node between the primary-side second upper arm V1 and the primary-side second lower arm /V1. The midpoint 207m is connected to the midpoint 211m via the primary-side first reactor 204a, the primary coil 202 and the primary-side second reactor 204b in the stated order.

The midpoints 207m and 211m are connected via the winding of the primary coil 202. The winding of the primary coil 202 is separated into a first primary winding 202a and a second primary winding 202b by a center tap 202m. The primary coil 202 has the center tap 202m drawn out from a mid connection point between the first primary winding 202a and the second primary winding 202b. The number of turns of the first primary winding 202a is equal to the number of turns of the second primary winding 202b.

The first input/output port 60a is connected to the primary-side full bridge circuit 200 and is a port provided between the primary-side positive bus 298 and the primary-side negative bus 299. The first input/output port 60a includes the terminals 613 and 614. The second input/output port 60c is connected to the center tap 202m at the primary side of the transformer 400, and is a port provided between the primary-side negative bus 299 and the center tap 202m of the primary coil 202. The second input/output port 60c includes the terminals 614 and 616.

The center tap 202m is connected to the high-potential-side terminal 616 of the second input/output port 60c. The center tap 202m is the mid connection point between the first primary winding 202a and the second primary winding 202b of the primary coil 202.

The secondary-side conversion circuit 30 is a secondary-side circuit including the secondary-side full bridge circuit 300 and the third input/output port 60b. The secondary-side full bridge circuit 300 is provided at the secondary side of the transformer 400. The secondary-side full bridge circuit 300 is a secondary-side power conversion part including a secondary coil 302 of the transformer 400, the secondary-side first upper arm U2, the secondary-side first lower arm /U2, the secondary-side second upper arm V2 and the secondary-side second lower arm /V2. The secondary-side first upper arm U2, the secondary-side first lower arm /U2, the secondary-side second upper arm V2 and the secondary-side second lower arm /V2 are, for example, switching devices including N-channel MOSFETs and body diodes (i.e., parasitic diodes) that are parasitic elements of the MOSFETs, respectively. Diodes can be additionally connected to the MOSFETs in parallel. FIG. 1 illustrates the diodes 85, 86, 87 and 88.

The secondary-side full bridge circuit 300 includes a secondary-side positive bus 398 connected to the high-potential-side terminal 618 of the third input/output port 60b and a secondary-side negative bus 399 connected to the low-potential-side terminal 620 of the third input/output port 60b.

A secondary-side first arm circuit 307 where the secondary-side first upper arm U2 and the secondary-side first lower arm /U2 are connected in series is connected between the secondary-side positive bus 398 and the secondary-side negative bus 399. The secondary-side first arm circuit 307 is a secondary-side first power conversion circuit part capable of carrying out a power conversion operation through turning-on/off switching operations of the secondary-side first upper arm U2 and the secondary-side first lower arm /U2 (i.e., a secondary-side U-phase power conversion circuit part). Also, between the secondary-side positive bus 398 and the secondary-side negative bus 399, a secondary-side second arm circuit 311 is connected where the secondary-side second upper arm V2 and the secondary-side second lower arm /V2 are connected in series, parallel to the secondary-side first arm circuit 307. The secondary-side second arm circuit 311 is a secondary-side second power conversion circuit part capable of carrying out a power conversion operation through turning-on/off switching operations of the secondary-side second upper arm V2 and the secondary-side second lower arm /V2 (i.e., a secondary-side V-phase power conversion circuit part).

In a bridge part connecting the midpoint 307m of the secondary-side first arm circuit 307 and the midpoint 311m of the secondary-side second arm circuit 311, the secondary coil 302 and a switch 303 are provided. In more detail of connection relationships in the bridge part, a tap 305 provided at one end of the secondary coil 302 or a tap 306 provided between the one end and the other end of the secondary coil 302 is selectively connected to the midpoint 307m of the secondary-side first arm circuit 307 via the switch 303. Further, a tap 301 provided at the other end of the secondary coil 302 is connected to the midpoint 311m of the secondary-side second arm circuit 311.

The midpoint 307m is a secondary-side first mid node between the secondary-side first upper arm U2 and the secondary-side first lower arm /U2. The midpoint 311m is a secondary-side second mid node between the secondary-side second upper arm V2 and the secondary-side second lower arm /V2. The midpoint 307m is connected to the midpoint 311m via the switch 303 and the winding of the secondary coil 302 in the stated order.

The midpoints 307m and 311m are connected via the switch 303 and the winding of the secondary coil 302. The winding of the secondary coil 302 is separated into a first secondary winding 302a and a second secondary winding 302b by the tap 306. The secondary coil 302 has the tap 306 drawn out from the connection point between the first secondary winding 302a and the second secondary 302b. The number of turns of the first secondary winding 302a is preferably less than the number of turns of the second secondary winding 302b in order to prevent the efficiency η acquired when the connecting destination of the midpoint 307m is switched by the switch 303 to the tap 306 from falling too much. However, it is also possible that the number of turns of the first secondary winding 302a is equal to or greater than the number of turns of the second secondary winding 302b. Note that the efficiency η is the power conversion efficiency between the primary-side ports and the secondary-side port.

The third input/output port 60b is connected to the secondary-side full bridge circuit 300 and is a port provided between the secondary-side positive bus 398 and the secondary-side negative bus 399. The third input/output port 60b includes the terminals 618 and 620.

In FIG. 1, the power supply apparatus 101 includes the sensor part 70. The sensor part 70 is a detection part detecting an input/output value Y at, at least one port of the first through third input/output ports 60a, 60c and 60b with a detection period and outputting a detection value Yd corresponding to the thus detected input/output value Y to the control part 50. The detection value Yd can be a detection voltage acquired from detecting the input/output voltage, a detection current acquired from detecting the input/output current or detection power acquired from detecting the input/output power. The sensor part 70 can be installed inside or outside the power supply circuit 10.

The sensor part 70 includes, for example, a voltage detection part that detects the input/output voltage appearing at, at least one of the first through third input/output ports 60a, 60c and 60b. The sensor part 70 includes, for example, a primary-side voltage detection part that detects, as a primary-side voltage detection value, at least one of the port voltages Va and Vc and a secondary-side voltage detection part that detects, as a secondary-side voltage detection value, the port voltage Vb.

The voltage detection part of the sensor part 70 includes, for example, a voltage sensor that monitors the input/output voltage value of at least one port and a voltage detection circuit that outputs a detection voltage corresponding to the input/output voltage value monitored by the voltage sensor to the control part 50.

The sensor part 70 includes, for example, a current detection part that detects the input/output current flowing through, at least one of the first through third input/output ports 60a, 60c and 60b. The sensor part 70 includes, for example, a primary-side current detection part that detects, as a primary-side current detection value, at least one of the port currents Ia and Ic and a secondary-side current detection part that detects, as a secondary-side current detection value, the port current Ib.

The current detection part of the sensor part 70 includes, for example, a current sensor that monitors the input/output current value of at least one port and a current detection circuit that outputs a detection current corresponding to the input/output current value monitored by the current sensor to the control part 50.

The power supply apparatus 101 includes the control part 50. The control part 50 is, for example, an electronic circuit including a microcomputer having a CPU inside. The control part 50 can be installed inside or outside the power supply circuit 10.

The control part 50 carries out feedback control of the power conversion operations of the power supply circuit 10 in such a manner that the detection value Yd of the input/output value of at least one of the first through third input/output ports 60a, 60c and 60b will converge to a target value Yo that is set for the port. The target value Yo is an instruction value that is, for example, set by the control part 50 or a predetermined device other than the control part 50 based on a driving condition prescribed for each load (for example, the primary-side low-voltage-system load 61c or so) connected to each input/output port. The target value Yo functions as an output target value when power is output by the port and functions as an input target value when power is input to the port. The target value Yo can be a target voltage value, a target current value or a target power value.

The control part 50 also carries out feedback control of the power conversion operations of the power supply circuit 10 in such a manner that the transmission power P transmitted between the primary-side conversion circuit 20 and the secondary-side conversion circuit 30 via the transformer 400 will converge to target transmission power Po that is set. The transmission power can also be called a power transmission amount. The target transmission power can also be called an instruction transmission power or a required power.

The control part 50 can carry out feedback control of the power conversion operations of the power supply circuit 10 by changing values of predetermined control parameters X and adjust the input/output value Y of each of the first through third input/output ports 60a, 60c and 60b of the power supply circuit 10. As main control parameters X, two sorts of control variants, i.e., phase differences φ and duty ratios D (turn-on times δ), can be cited.

The phase differences φ are time lags in switching timing between the power conversion circuits of the same phases between the primary-side full bridge circuit 200 and the secondary-side full bridge circuit 300. The duty ratios D (the turn-on times δ) are duty ratios (turn-on times) of switching waveforms in the respective power conversion circuits in the primary-side full bridge circuit 200 and the secondary-side full bridge circuit 300.

These two types of control parameters X can be controlled mutually independently. The control part 50 changes the input/output value Y at each of the input/output ports of the power supply circuit 10 by carrying out duty-ratio control and/or phase control of the primary-side full bridge circuit 200 and the secondary-side full bridge circuit 300 using the phase differences φ and the duty ratios D (the turn-on times δ).

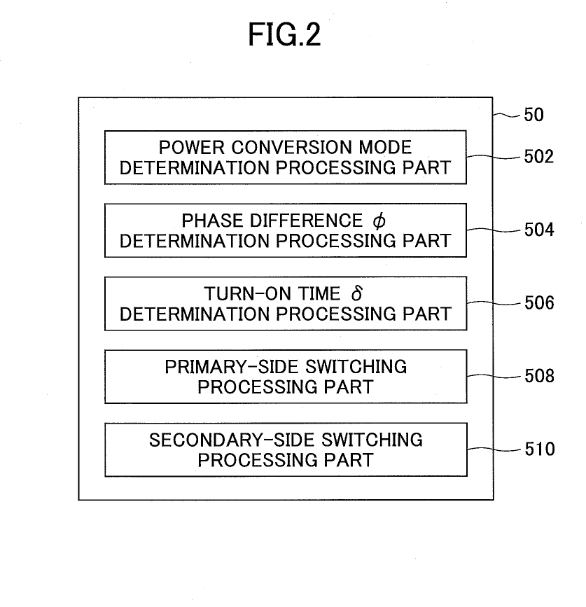

FIG. 2 is a block diagram of the control part 50. The control part 50 carries out switching control of each switching device such as the primary-side first upper arm U1 in the primary-side conversion circuit 20 and each switching device such as the secondary-side first upper arm U2 in the secondary-side conversion circuit 30. The control part 50 includes a power conversion mode determination processing part 502, a phase difference φ determination processing part 504, a turn-on time δ determination processing part 506, a primary-side switching processing part 508 and a secondary-side switching processing part 510. The control part 50 is, for example, an electronic circuit having a microcomputer with a CPU inside.

The power conversion mode determination processing part 502 determines an operation mode from among power conversion modes A, B, D, E, G and H of the power supply circuit 10 which will be described below based on, for example, a predetermined external signal (for example, a signal indicating a deviation between the detection value Yd and the target value Yo at any port). The power conversion mode A is a mode of converting the power that is input from the first input/output port 60a and outputting the converted power to the second input/output port 60c. The power conversion mode B is a mode of converting the power that is input from the first input/output port 60a and outputting the converted power to the third input/output port 60b.

The power conversion mode D is a mode of converting the power that is input from the second input/output port 60c and outputting the converted power to the first input/output port 60a. The power conversion mode E is a mode of converting the power that is input from the second input/output port 60c and outputting the converted power to the third input/output port 60b.

The power conversion mode G is a mode of converting the power that is input from the third input/output port 60b and outputting the converted power to the first input/output port 60a. The power conversion mode H is a mode of converting the power that is input from the third input/output port 60b and outputting the converted power to the second input/output port 60c.

The phase difference φ determination processing part 504 sets the phase differences φ of the switching periodic operations of the switching devices between the primary-side conversion circuit 20 and the secondary-side conversion circuit 30 to cause the power supply circuit 10 to function as a DC-DC converter circuit.

The turn-on time δ determination processing part 506 sets the turn-on times δ of the primary-side conversion circuit 20 to cause the primary-side conversion circuit 20 to function as a boosting/stepping-down circuit. The turn-on time δ determination processing part 506 sets the turn-on times δ of the secondary-side conversion circuit 30, and, for example, sets the turn-on times δ of the secondary-side conversion circuit 30 to the same value as the turn-on times δ of the primary-side conversion circuit 20.

The primary-side switching processing part 508 carries out switching control of the primary-side first upper arm U1, the primary-side first lower arm /U1, the primary-side second upper arm V1 and the primary-side second lower arm /V1 based on the outputs of the power conversion mode determination processing part 502, the phase difference φ determination processing part 504 and the turn-on time δ determination processing part 506.

The secondary-side switching processing part 510 carries out switching control of the secondary-side first upper arm U2, the secondary-side first lower arm /U2, the secondary-side second upper arm V2 and the secondary-side second lower arm /V2 based on the outputs of the power conversion mode determination processing part 502, the phase difference φ determination processing part 504 and the turn-on time δ determination processing part 506.

### <Operations of Power Supply Apparatus 101>

Operations of the power supply apparatus 101 will now be described using FIGS. 1 and 2. For example, when an external signal requests the power supply circuit 10 to operate according to the power conversion mode E, the power conversion mode determination processing part 502 of the control part 50 determines the power conversion mode of the power supply circuit 10 as the mode E. At this time, the power that is input to the second input/output port 60c is boosted through the boosting function of the primary-side conversion circuit 20, the power thus boosted is transmitted to the third input/output port 60b through the function of the DC-DC converter of the power supply circuit 10.

For example, when an external signal requests the power supply circuit 10 to operate according to the power conversion mode H, the power conversion mode determination processing part 502 of the control part 50 determines the power conversion mode of the power supply circuit 10 as the mode H. At this time, the power that is input to the third input/output port 60b is transmitted to the first input/output port 60a through the function of the DC-DC converter of the power supply circuit 10, and the thus transmitted power is stepped down through the stepping-down function of the primary-side conversion circuit 20 and the thus stepped down power is output to the second input/output port 60c.

The boosting/stepping-down function of the primary-side conversion circuit 20 will now be described in detail. Focusing on the second input/output port 60c and the first input/output port 60a, the terminal 616 of the second input/output port 60c is connected to the midpoint 207m of the primary-side first arm circuit 207 via the primary-side first winding 202a and the primary-side first reactor 204a connected to the first primary winding 202a in series. Also, both ends of the primary-side first arm circuit 207 are connected to the first input/output port 60a. Thus, it can be said that the boosting/stepping-down circuit is connected between the terminal 616 of the second input/output port 60c and the first input/output port 60a.

Also, the terminal 616 of the second input/output port 60c is connected to the midpoint 211m of the primary-side second arm circuit 211 via the second primary winding 202b and the primary-side second reactor 204b connected to the second primary winding 202b in series. Further, both ends of the primary-side second arm circuit 211 are connected to the first input/output port 60a. Thus, it can be said that the boosting/stepping-down circuits are connected in parallel between the terminal 616 of the second input/output port 60c and the first input/output port 60a.

Next, the function of the power supply circuit 10 as the DC-DC converter circuit will be described in detail. Focusing on the first input/output port 60a and the third input/output port 60b, the primary-side full bridge circuit 200 is connected to the first input/output port 60a and the secondary-side full bridge circuit 300 is connected to the third input/output port 60b. Also, as a result of the primary coil 202 provided in the bridge part of the primary-side full bridge circuit 200 and the secondary coil 302 provided in the bridge part of the secondary-side full bridge circuit 300 being magnetically coupled to one another with a coupling coefficient k_{T}, the transformer 400 functions as a transformer having a winding turn ratio 1:N. Therefore, it is possible to convert the power that is input to the first input/output port 60a and transmit the converted power to the third input/output port 60b or convert the power that is input to the third input/output port 60b and transmit the converted power to the first input/output port 60a, by adjusting the phase differences φ of the switching periodic operations of the switching devices in the primary-side full bridge circuit 200 and the secondary-side full bridge circuit 300.

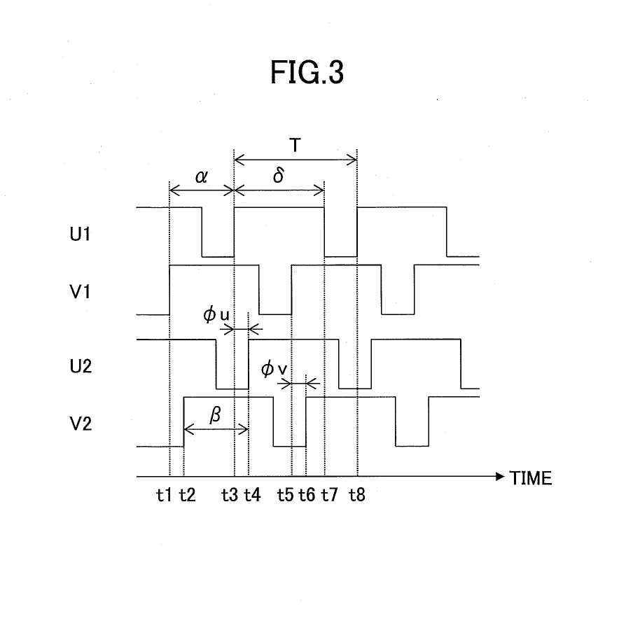

FIG. 3 illustrates a timing chart of a turning-on/off switching waveform of each arm included in the power supply circuit 10 appearing due to control of the control part 50. In FIG. 3, U1 denotes a turn-on/off waveform of the primary-side first upper arm U1; V1 denotes a turn-on/off waveform of the primary-side second upper arm V1; U2 denotes a turn-on/off waveform of the secondary-side first upper arm U2; and V2 denotes a turn-on/off waveform of the secondary-side second upper arm V2. Respective turn-on/off waveforms of the primary-side first lower arm /U1, the primary-side second lower arm /V1, the secondary-side first lower arm /U2 and the secondary-side second lower arm /V2 (not shown) are acquired from inverting the respective turn-on/off waveforms of the primary-side first upper arm U1, the primary-side second upper arm V1, the secondary-side first upper arm U2 and the secondary-side second upper arm V2, respectively. Note that it is preferable to provide dead times between the turn-on/off waveforms of the upper and lower arms in order to avoid passing through currents otherwise flowing due to simultaneous turning on of both upper and lower arms. In FIG. 3, the high level represents a turned-on state and the low level represents a turned-off state.

It is possible to change the boosting/stepping-down ratio of the primary-side conversion circuit 20 by changing the turn-on times δ of the respective U1 and V1.

The boosting/stepping-down ratio of the primary-side conversion circuit 20 is determined by duty ratios D that are the proportions of the turn-on times δ to the switching periods T of the switching devices (arms) of the primary-side full bridge circuit 200. The boosting/stepping-down ratio of the primary-side conversion circuit 20 is the voltage transformation ratio between the first input/output port 60a and the second input/output port 60c.

Therefore, for example,

boosting/stepping-down ratio of primary-side conversion circuit 20=(voltage of second input/output port 60c)/(voltage of first input/output port 60a)=δ/T

Note that the turn-on time δ in FIG. 3 indicates the turn-on time of the primary-side first upper arm U1 and the primary-side second upper arm V1. Also, the turn-on time δ in FIG. 3 indicates the turn-on time of the secondary-side first upper arm U2 and the secondary-side second upper arm V2. Further, the switching period T of the arms in the primary-side full bridge circuit 200 and the switching period T of the arms in the secondary-side full bridge circuit 300 are the equal periods.

In normal operation, the control part 50 causes the switching devices to operate with the phase difference α between U1 and V1 that is, for example, 180 degrees (π). Also, in normal operation, the control part 50 causes the switching devices to operate with the phase difference β between U2 and V2 that is, for example, 180 degrees (π). The phase difference α between U1 and V1 is a time difference between the time t1 and the time t3. The phase difference β between U2 and V2 is a time difference between the time t2 and the time t4.

Further, the control part 50 is capable of adjusting the transmission power P transmitted between the primary-side conversion circuit 20 and the secondary-side conversion circuit 30 by changing at least one of the phase difference φu between U1 and U2 and the phase difference φv between V1 and V2. The phase difference φu is a time difference between the time t3 and the time t4. The phase difference φv is a time difference between the time t5 and the time t6.

The control part 50 is one example of a control part that controls the transmission power P transmitted between the primary-side full bridge circuit 200 and the secondary-side full bridge circuit 300 via the transformer 400 by adjusting the phase difference φu and the phase difference φv.

The phase difference φu is a time difference between switching of the primary-side first arm circuit 207 and switching of the secondary-side first arm circuit 307. For example, the phase difference φu is a difference between the time t3 of turning on the primary-side first upper arm U1 and the time t4 of turning on the secondary-side first upper arm U2. Switching the primary-side first arm circuit 207 and switching the secondary-side first arm circuit 307 are controlled by the control part 50 to be mutually in the same phase (i.e., in U-phase). Similarly, the phase difference φv is a time difference between switching the primary-side second arm circuit 211 and switching the secondary-side second arm circuit 311. For example, the phase difference φv is a difference between the time t5 of turning on the primary-side second upper arm V1 and the time t6 of turning on the secondary-side second upper arm V2. Switching the primary-side second arm circuit 211 and switching the secondary-side second arm circuit 311 are controlled by the control part 50 to be mutually in the same phase (i.e., in V-phase).

With the phase difference φu>0 or the phase difference φv>0, it is possible to transmit transmission power P from the primary-side conversion circuit 20 to the secondary-side conversion circuit 30. With the phase difference φu<0 or the phase difference φv<0, it is possible to transmit transmission power P from the secondary-side conversion circuit 30 to the primary-side conversion circuit 20. In other words, between the power conversion circuit parts of the same phase between the primary-side full bridge circuit 200 and the secondary-side full bridge circuit 300, transmission power P is transmitted from the full bridge circuit having the power conversion circuit part in which the upper arm is turned on earlier to the full bridge circuit having the power conversion circuit part in which the upper arm is turned on later.

In the case of FIG. 3 for example, the time t3 of turning on the primary-side first upper arm U1 is earlier than the time t4 of turning on the secondary-side first upper arm U2. Therefore, transmission power P is transmitted from the primary-side full bridge circuit 200 including the primary-side first arm circuit 207 having the primary-side first upper arm U1 to the secondary-side full bridge circuit 300 including the secondary-side first arm circuit 307 having the secondary-side first upper arm U2. Similarly, the time t5 of turning on the primary-side second upper arm V1 is earlier than the time t6 of turning on the secondary-side second upper arm V2. Therefore, transmission power P is transmitted from the primary-side full bridge circuit 200 including the primary-side second arm circuit 211 having the primary-side second upper arm V1 to the secondary-side full bridge circuit 300 including the secondary-side second arm circuit 311 having the secondary-side second upper arm V2.

The phase differences φ are deviations in timing (i.e., time lags) between the power conversion circuit parts of the same phases between the primary-side full bridge circuit 200 and the secondary-side full bridge circuit 300. For example, the phase difference φu is a deviation in switching timing between the corresponding phases between the primary-side first arm circuit 207 and the secondary-side first arm circuit 307. The phase difference φv is a deviation in switching timing between the corresponding phases between the primary-side second arm circuit 211 and the secondary-side second arm circuit 311.

The control part 50 normally carries out control where the phase difference φu and the phase difference φv are made equal to one another. However, control part 50 is allowed to carry out control where the phase difference φu and the phase difference φv are deviated from one another within a range where the preciseness required for transmission power P is satisfied. In other words, normally control is carried out in such a manner that the phase difference φu and the phase difference φv have the same values. However, if the preciseness required for transmission power P is satisfied, the phase difference φu and the phase difference φv can have mutually different values.

Therefore, for example, when an external signal requests the power supply circuit 10 to operate according to the power conversion mode E, the power conversion mode determination processing part 502 of the control part 50 determines the power conversion mode of the power supply circuit 10 as the mode E. Then, the turn-on time δ determination processing part 506 sets the turn-on times δ prescribing the boosting ratio for causing the primary-side conversion circuit 20 to function as a boosting circuit to boost the power that is input to the second input/output port 60c and output the boosted power to the first input/output port 60a. The turn-on time δ determination processing part 506 sets the turn-on times δ of the secondary-side conversion circuit 30 to be the same as the turn-on times δ of the primary-side conversion circuit 20. Further, the phase difference φ determination processing part 504 sets the phase differences φ for boosting the power that is input to the first input/output port 60a and transmitting a desired power transmission amount of the boosted power to the third input/output port 60b.

The primary-side switching processing part 508 carries out switching control of the respective switching devices of the primary-side first upper arm U1, the primary-side first lower arm /U1, the primary-side second upper arm V1 and the primary-side second lower arm /V1 in such a manner as to cause the primary-side conversion circuit 20 to function as a boosting circuit and cause the primary-side conversion circuit 20 to function as a part of a DC-DC converter circuit.

The secondary-side switching processing part 510 carries out switching control of the respective switching devices of the secondary-side first upper arm U2, the secondary-side first lower arm /U2, the secondary-side second upper arm V2 and the secondary-side second lower arm /V2 in such a manner as to cause the secondary-side conversion circuit 30 to function as a part of a DC-DC converter circuit.

Also for a case where the power conversion mode is a mode other than the mode E, a similar thought holds.

Thus, it is possible to cause the primary-side conversion circuit 20 as a boosting circuit or a stepping-down circuit and also cause the power supply circuit 10 to function as a bidirectional DC-DC converter circuit. Therefore, it is possible to carry out power conversion according to any one of the power conversion modes mentioned above. In other words, it is possible to carry out power conversion between two input/output ports selected from among the three input/output ports.

Transmission power P (also referred to as a power transmission amount P) adjusted by the control part 50 according to the phase differences φ is power transmitted from one conversion circuit to another conversion circuit via the transformer 400 in the primary-side conversion circuit 20 and the secondary-side conversion circuit 30, and is expressed by the following Formula 1:

P=(N×Va×Vb)/(π×ω×L)×F(D,φ) Formula 1

In Formula 1, N denotes the winding turn ratio of the transformer 400; Va denotes the port voltage of the first input/output port 60a; and Vb denotes the port voltage of the third input/output port 60b. π denotes the circular constant. ω (=2π×f=2π/T) denotes an angular frequency of switching of the primary-side conversion circuit 20 and the secondary-side conversion circuit 30. f denotes a switching frequency of the primary-side conversion circuit 20 and the secondary-side conversion circuit 30. T denotes a switching period of the primary-side conversion circuit 20 and the secondary-side conversion circuit 30. L denotes an equivalent inductance of the magnetic coupling reactors 204 and 304 and the transformer 400 concerning power transmission. F(D, φ) denotes a function having the duty ratios D and the phase differences φ as variables and is a variable monotonically increasing as the phase differences φ increase without depending on the duty ratios D. The duty ratios D and the phase differences φ are control parameters that are designed to vary in ranges limited by predetermined upper and lower limits.

The control part 50 adjusts the transmission power P by changing the phase differences φ in such a manner that the port voltage Vp at, at least one predetermined port from among the primary-side ports and the secondary-side port will converge to a target port voltage Vo. Therefore, the control part 50 can prevent the port voltage Vp from falling with respect to the target port voltage Vo by adjusting the transmission power P by changing the phase differences φ even when the consumption current at a load connected to the predetermined port increases.

For example, the control part 50 adjusts the transmission power P by changing the phase differences φ in such a manner that the port voltage Vp at a port of the primary-side ports or the secondary-side port to which the transmission power P is transmitted will converge to the target port voltage Vo. Therefore, the control part 50 can prevent the port voltage Vp from falling with respect to the target port voltage Vo by adjusting transmission power P to increase it by changing the phase differences φ to increase them even when the consumption current at a load connected to the port to which the transmission power P is transmitted increases.

### <Method of Switching Number of Turns of Coil of Transformer>

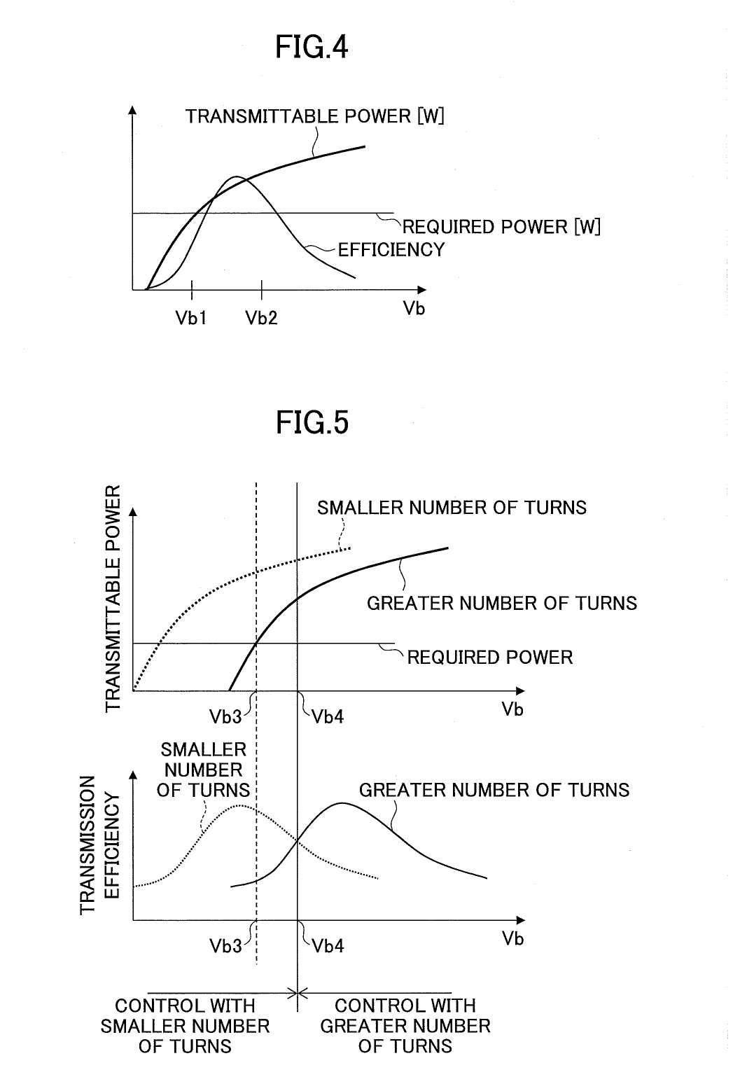

FIG. 4 illustrates one example of relations among the port voltage Vb, the transmittable power Pmax and the efficiency η when the port voltages Va and Vc are fixed.

The port voltage Va is the voltage between both ends of the primary-side full bridge circuit 200 (i.e., the voltage between the primary-side positive bus 298 and the primary-side negative bus 299), the port voltage Vc is the voltage between the center tap 202m and the primary negative bus 299, and the port voltage Vb is the voltage between both ends of the secondary-side full bridge circuit 300 (i.e., the voltage between the secondary-side positive bus 398 and the secondary-sided negative bus 399).

The transmittable power Pmax is the transmittable transmission power P (in other words, the maximum value that the transmission power P can have) and the value calculable according to Formula 1. Therefore, the transmittable power Pmax is a value determined depending on (Vb/Va).

The efficiency η is the power conversion efficiency between the primary-side ports and the secondary-side port of the power supply circuit 10. For example, the efficiency η can be expressed by the ratio of the output voltage to the input voltage in the power supply circuit 10.

Assuming that Pin denotes the input power that is input to one of the primary-side ports and the secondary-side port, Pout denotes the output power that is output from the other-side port, Vin denotes the input voltage that is input to the one of the primary-side ports and the secondary-side port, Vout denotes the output voltage that is output from the other-side port, Iin denotes the input current that is input to the one of the primary-side ports and the secondary-side port, and Iout denotes the output current that is output from the other-side port, the efficiency η can be expressed as follows,

efficiency η=Pout/Pin=(Vout×Iout)/(Vin×Iin) Formula 2

For example, in the power supply circuit 10 of FIG. 1, when the port power Pb that is input to the third input/output port is converted in voltage and the port power Pa thus converted in voltage is output to the first input/output port, the power Pa at the first input/output port is converted in voltage and the port power Pc thus converted in voltage is output to the second input/output port, the efficiency η of the power supply circuit 10 can be expressed as follows according to Formula 2,

η=(Va×Ia+Vc×Ic)/(Vb×Ib) Formula 3

As shown in FIG. 4, when, for example, in a state where the port voltages Va and Vc are fixed and the port voltage Vb falls from Vb2 to Vb1 excessively due to voltage reduction of the main battery 62b, the transmittable power Pmax falls to be less than the required power Po and also the efficiency η degrades. When the transmittable power Pmax falls to be less than the required power Po, such a situation may occur where the required power becomes short at the port that is the transmission destination of the transmission power P.

In order to avoid such a situation, the power supply apparatus 101 of FIG. 1 has, the switch 303. The switch 303 is one example of a switching circuit selectively switching the number of turns Tb of the winding of the secondary coil 302 between the midpoint 307m and the midpoint 311m. As a specific example of the switch 303, it is possible to cite a relay (a semiconductor relay, a mechanical relay or so), a slider switch, a rotary switch or so.

In the power supply apparatus 101, it is possible to change the winding turn ratio N of the transformer 400 as a result of the number of turns Tb of the winding between the midpoint 307m and the midpoint 311m by the switch 303. As a result, as shown in FIG. 5, it is possible to transmit the sufficient transmission power P efficiently even when the voltage ratio between the port voltage Va and the port voltage Vb varies.

FIG. 5 illustrates one example of relations among the port voltage Vb, the transmittable power Pmax and the efficiency η depending on the difference in the number of turns Tb when the port voltages Va and Vc are fixed.

As a result of, for example, the switch 303 switching the number of turns Tb depending on the port voltage Vb, it is possible to transmit the sufficient transmission power efficiently even when the voltage ratio between the port voltage Va and the port voltage Vb varies.

For example, when detecting that the port voltage Vb falls to be less than a predetermined threshold Vb4, the control part 50 controls the switching operation of the switch 303 in such a manner as to reduce the number of turns Tb. As a result of the number of turns Tb being thus reduced when the port voltage Vb falls to be less than the threshold Vb4, it is possible to improve the efficiency η compared to that when the number of turns Tb is greater, as shown in FIG. 5, and it is possible to increase the margin of the transmittable power Pmax with respect to the required power Po.

In contrast thereto, when, for example, detecting that the port voltage Vb increases to be greater than the predetermined threshold Vb4, the control part 50 controls the switching operation of the switch 303 in such a manner as to increase the number of turns Tb. As a result of the number of turns Tb being thus increased when the port voltage Vb increases to be greater than the threshold Vb4, it is possible to improve the efficiency n compared to that when the number of turns Tb is smaller while the margin of the transmittable power Pmax with respect to the required power Po is ensured, as shown in FIG. 5.

The threshold Vb4 is set to the voltage at which the magnitude relation between the respective efficiencies η is reversed due to the increase and reduction of the number of turns Tb.

It is possible that the switch 303 switches the number of turns Tb depending on the transmittable power Pmax calculated by the control part 50 according to Formula 1, for example. By thus switching the number of turns Tb according to the transmittable power Pmax, it is possible to efficiently transmit the sufficient transmission power P even when the voltage ratio between the port voltage Va and the port voltage Vb varies.

For example, it is possible that, when detecting that the transmittable power Pmax calculated according to Formula 1 by the control part 50 has fallen to be less than the predetermined threshold (for example, the required power Po), the control part 50 controls the switching operation of the switch 303 in such a manner as to reduce the number of turns Tb. The control part 50 can detect that the transmittable power has fallen to be less than the predetermined threshold (for example, the required power Po) by, for example, detecting that the port voltage Vb has fallen to be less than a predetermined threshold Vb3 (<Vb4). As a result of the number of turns Tb being reduced when the transmittable power Pmax falls to be less than the required power Po, it is possible to improve the efficiency η compared to that when the number of turns Tb is greater, as shown in FIG. 5, and it is possible to increase the margin of the transmittable power Pmax with respect to the required power Po.

In FIG. 1, the switch 303 changes the winding turn ratio N by selecting the connecting destination of the midpoint 307m from among the plurality of taps 305 and 306 of the secondary coil 302. For example, it is possible to reduce the winding turn ratio N by selecting the tap 306 as the connecting destination of the midpoint 307m by the switch 303 because it is possible to reduce the number of turns Tb in comparison to the case of selecting the tap 305. In contrast thereto, it is possible to increase the winding turn ratio N by selecting the tap 305 as the connecting destination of the midpoint 307m by the switch 303 because it is possible to increase the number of turns Tb in comparison to the case of selecting the tap 306.

By selecting, with the switch 303, the tap 305 as the connecting destination of the midpoint 307m, it is possible to switch the number of turns Tb to the total number of turns of the secondary coil 302 (in the case of FIG. 1, the sum total of the number of turns of the first secondary winding 302a and the number of turns of the second secondary winding 302b). On the other hand, by selecting, with the switch 303, the tap 306 as the connecting destination of the midpoint 307m, it is possible to switch the number of turns Tb to the number of turns less than the total number of turns of the secondary coil 302 (in the case of FIG. 1, the number of turns of the second secondary winding 302b).

The winding turn ratio N is expressed by “(total number of turns of secondary coil 302)/(total number of turns of primary coil 202)” when the connecting destination of the midpoint 307m is the tap 305 and “(number of turns of second secondary coil 302b)/(total number of turns of primary coil 202)” when the connecting destination of the midpoint 307m is the tap 306. Note that the total number of turns of the primary coil 202 is, in the case of FIG. 1, the sum total of the number of turns of the first primary winding 202a and the number of turns of the second primary winding 202b.

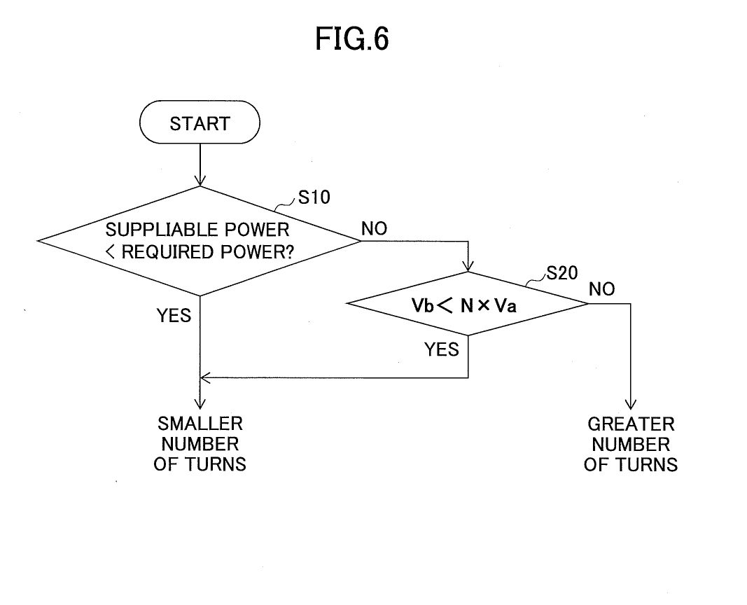

FIG. 6 is a flowchart illustrating one example of a method of switching the number of turns Tb.

In Step S10, the control part 50 determines the magnitude relation between the transmittable power Pmax and the required power Po for switching the number of turns Tb depending on the transmittable power Pmax.

When, for example, determining that the transmittable power Pmax is less than the required power Po based on the detection value of the port voltage Vb (for example, in FIG. 5, when it is detected that the port voltage Vb is less than the threshold Vb3), the control part 50 can increase the transmittable power Pmax to be greater than the required power Po and to increase the efficiency η compared to the case where the number of turns Tb is greater by reducing the number of turns Tb. On the other hand, when determining that, for example, the transmittable power Pmax is greater than the required power Po based on the detection value of the port voltage Vb, the control part 50 executes Step S20.

In Step S20, the control part 50 determines the magnitude relation between the voltage ratio (Vb/Va) and the winding turn ratio N (in other words, the magnitude relation between the port voltage Vb and the product (N×Va) of the winding turn ratio N and the port voltage Va) for switching the number of turns Tb according to the voltage ratio (Vb/Va) between the port voltage Va and the port voltage Vb.

When determining that, for example, the voltage ratio (Vb/Va) is less than the winding turn ratio N due to a reduction in the port voltage Vb or an increase in the port voltage Va based on the detection values of the port voltages Va and Vb (for example, in FIG. 5, when it is determined that the port voltage Vb is greater than or equal to the threshold Vb3 and less than the threshold Vb4), the control part 50 can ensure the transmittable power Pmax greater than the required power Po, and increase the efficiency η compared to the case where the number of turns Tb is greater, by, for example, reducing the number of turns Tb.

On the other hand, when determining that, for example, the voltage ratio (Vb/Va) is greater than the winding turn ratio N due to an increase in the port voltage Vb or a reduction in the port voltage Va based on the detection values of the port voltages Va and Vb (for example, in FIG. 5, when it is determined that the port voltage Vb is greater than or equal to the threshold Vb4), the control part 50 can ensure the transmittable power Pmax greater than the required power Po, and increase the efficiency η compared to the case where the number of turns Tb is smaller, by, for example, increasing the number of turns Tb.

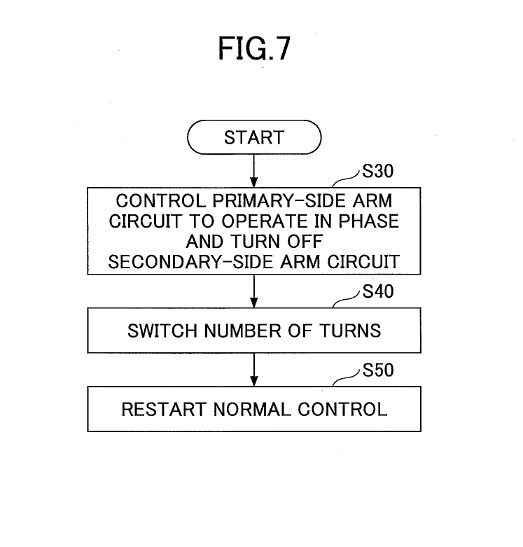

FIG. 7 is a flowchart illustrating one example of a method of controlling each full bridge circuit when switching the number of turns Tb.

In Step S40, the control part 50 executes Step S30 before switching the connecting destination of the midpoint 307m to either the tap 305 or the tap 306 using the switch 303. In Step S30, the control part 50 carries out switching control of the switching states of the primary-side first arm circuit 207 and the primary-side second arm circuit 211 in phase, and also, controls the switching states of the secondary-side first arm circuit 307 and the secondary-side second arm circuit 311 to turn off them.

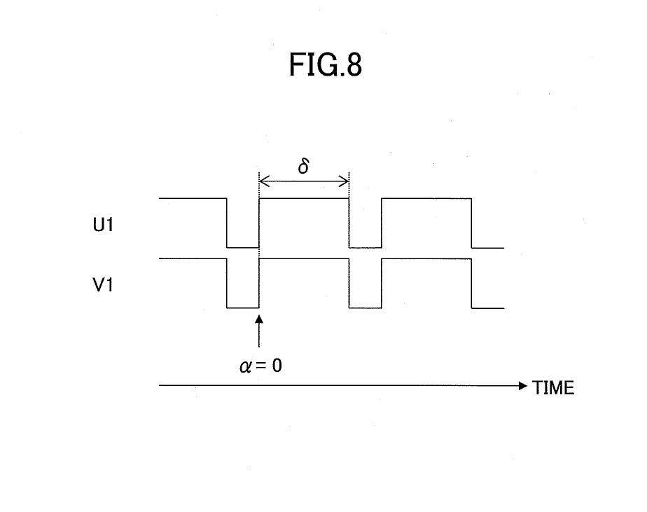

As shown in FIG. 8, the control part 50 carries out switching control of the switching states of the primary-side first arm circuit 207 and the primary-side second arm circuit 211 in phase by setting the phase difference α between U1 and V1 to zero. In FIG. 8, U1 shows a turn-on/off waveform of the primary-side first upper arm U1, and V1 shows a turn-on/off waveform of the primary-side first upper arm V1. Respective turn-on/off waveforms of the primary-side first lower arm /U1 and the primary-side second lower arm /V1 (not shown) are acquired from inverting the respective turn-on/off waveforms of the primary-side first upper arm U1 and the primary-side second upper arm V1, respectively. Note that it is preferable to provide dead times between the turn-on/off waveforms of the upper and lower arms in order to avoid passing through currents otherwise flowing due to simultaneous turning on of both upper and lower arms. In FIG. 8, the high level represents a turned-on state and the low level represents a turned-off state.

On the other hand, the control part 50 controls the switching states of the secondary-side first arm circuit 307 and the secondary-side second arm circuit 311 to turn off them by controlling the switching states of the secondary-side first upper arm U2, the secondary-side first lower arm /U2, the secondary-side second upper arm V2 and the secondary-side second lower arm /V2 to turn off them.

Through Step S30, the current i1 flowing from the midpoint 207m to the first primary winding 202a and the current i2 flowing from the midpoint 211m to the second primary winding 202b become equal to one another. As a result, the magnetic flux variations in the transformer 400 are cancelled, and no voltage appears between both ends of the secondary coil 302. During a period of time in which no voltage appears between both ends of the secondary coil 302, it is possible to open the connection between the midpoint 307m and the tap of the secondary coil 302.

Also, through Step S30, the control part is capable of continuing the state where the primary-side full bridge circuit 200 is caused to function as a boosting circuit or a stepping-down circuit even when the phase difference α is zero. Thus, it is possible to ensure an interchange of power between the first input/output port 60a and the second input/output port 60c.

In Step S40, the control part 50 switches the connecting destination of the midpoint 307m to either the tap 305 or the tap 306 by controlling the switching operation of the switch 303 during the period of time in which no voltage appears between both ends of the secondary coil 302 through Step S30. Thus, it is possible to positively switch the number of turns Tb.

For example, in a state where the tap 305 of the taps 305 and 306 is connected with the midpoint 307m, the switch 303 connects the other tap 306 with the midpoint 307m after cutting the connection of the tap 305 with the midpoint 307m. In contrast thereto, in a state where the tap 306 of the taps 305 and 306 is connected with the midpoint 307m, the switch 303 connects the other tap 305 with the midpoint 307m after cutting the connection of the tap 306 with the midpoint 307m.

After the completion of switching the tap in step S40, the control part 50 restarts normal switching control shown in FIG. 3 in Step S50 for the primary-side full bridge circuit 200 and the secondary-side full bridge circuit 300.

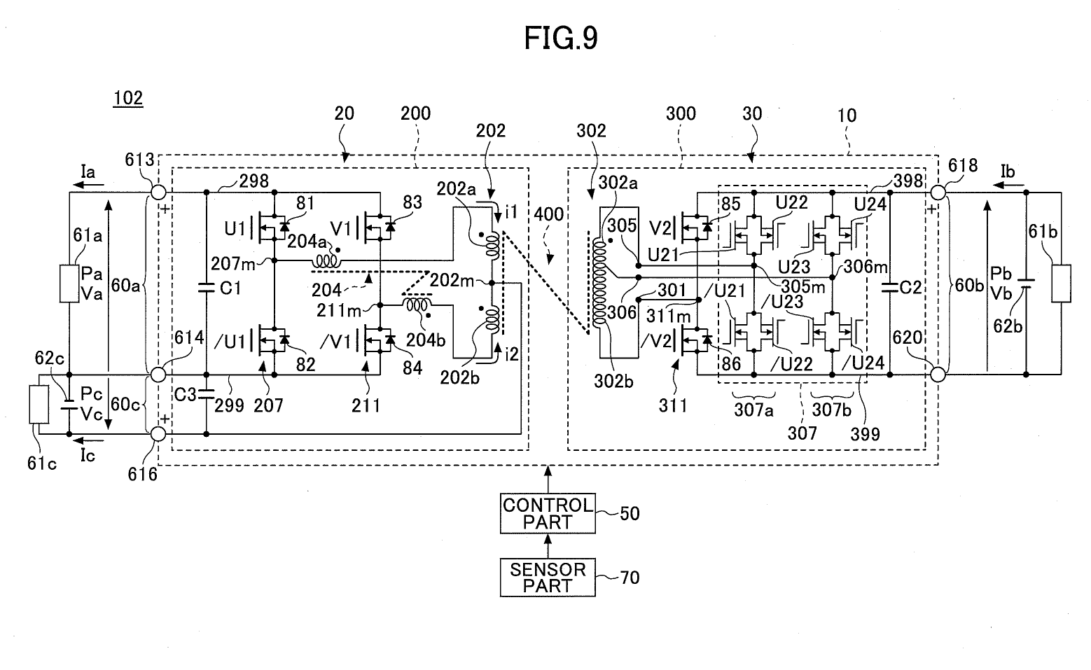

FIG. 9 is a block diagram illustrating a configuration example of a power supply apparatus 102 as another embodiment of a power conversion apparatus. The duplicate description of the same configuration and advantageous effects as those of the above-described configuration example will be omitted.

In the case of FIG. 9, the secondary-side first arm circuit 307 has, in parallel, an arm circuit part 307a having a midpoint 305m connected with a tap 305 of the secondary coil 302 and an arm circuit part 307b having a midpoint 306m connected with another tap 306 of the secondary coil 302. In this case, the arm circuit part 307a and the arm circuit part 307b selectively function as a switching circuit switching the number of turns Tb of the winding of the secondary coil 302 between the midpoint of the secondary-side first arm circuit 307 and the midpoint 311m of the secondary-side second arm circuit 311.

The arm circuit part 307a includes a pair of upper arms U21 and U22 provided on a high side of the midpoint 305m and a pair of lower arms /U21 and /U22 provided on a low side of the midpoint 305m. The upper arms U21 and U22 are connected mutually in parallel, and also, the lower arms /U21 and /U22 are connected mutually in parallel.

The arm circuit part 307b includes a pair of upper arms U23 and U24 provided on a high side of the midpoint 306m and a pair of lower arms /U23 and /U24 provided on a low side of the midpoint 306m. The upper arms U23 and U24 are connected mutually in parallel, and also, the lower arms /U23 and /U24 are connected mutually in parallel.

The respective arms included in the arm circuit parts 307a and 307b are, for example, switching devices such as MOSFETs.

The control part 50 continuously turns off the arms U23, U24, /U23 and /U24, respectively, for increasing the number of turns Tb of the winding of the secondary coil 302 between the midpoint of the secondary-side first arm circuit 307 and the midpoint 311m of the secondary-side second arm circuit 311. By continuously turning off the arms U23, U24, /U23 and /U24, respectively, it is possible to cause the tap 306 to be an open end. Thus, it is possible to switch the number of turns Tb to be the total number of turns of the secondary coil 302 between the midpoint 305m and the midpoint 311m.

Further, when increasing the number of turns Tb, the control part 50 can cause the arms U22 and /U22 to function as the diodes 87 and 88 shown in FIG. 1, respectively, by continuously turning on the arms U22 and /U22, respectively.

Therefore, in FIG. 9, the control part 50 can transmit the transmission power P in a state where the number of turns Tb is increased by carrying out turning-on/off control of U21 and /U21 in a state where U23, U24, /U23 and /U24 are continuously turned off and U22 and /U22 are continuously turned on.

On the other hand, the control part 50 continuously turns off the arms U21, U22, /U21 and /U22, respectively, for reducing the number of turns Tb of the winding of the secondary coil 302 between the midpoint of the secondary-side first arm circuit 307 and the midpoint 311m of the secondary-side second arm circuit 311. By continuously turning off the arms U21, U22, /U21 and /U22, respectively, it is possible to cause the tap 305 to be an open end. Thus, it is possible to switch the number of turns Tb to be the number of turns of the second secondary coil 302b between the midpoint 306m and the midpoint 311m.

Further, when reducing the number of turns Tb, the control part 50 can cause the arms U24 and /U24 to function as the diodes 87 and 88 shown in FIG. 1, respectively, by continuously turning on the arms U24 and /U24, respectively.

Therefore, in FIG. 9, the control part 50 can transmit the transmission power P in a state where the number of turns Tb is reduced by carrying out turning-on/off control of U23 and /U23 in a state where U21, U22, /U21 and /U22 are continuously turned off and U24 and /U24 are continuously turned on.

Thus, the control part 50 can adjust the above-described phase difference φu (see FIG. 3) by carrying out switching operations of the arm circuit part 307a (in other words, turning-on/off control of U21 and /U21 in a state where U22 and /U22 are continuously turned on) when all the arms in the arm circuit part 307b functioning as a switching circuit for switching the number of turns Tb are turned off. On the other hand, the control part 50 can adjust the above-described phase difference φu by carrying out switching operations of the arm circuit part 307b (in other words, turning-on/off control of U23 and /U23 in a state where U24 and /U24 are continuously turned on) when all the arms in the arm circuit part 307a functioning as a switching circuit for switching the number of turns Tb are turned off.

Further, by providing the arm circuit parts for the taps of the secondary coil, respectively, as shown in FIG. 9, it is possible to miniaturize the portion functioning as a switching circuit switching the number of turns Tb while avoiding degradation in the efficiency η.

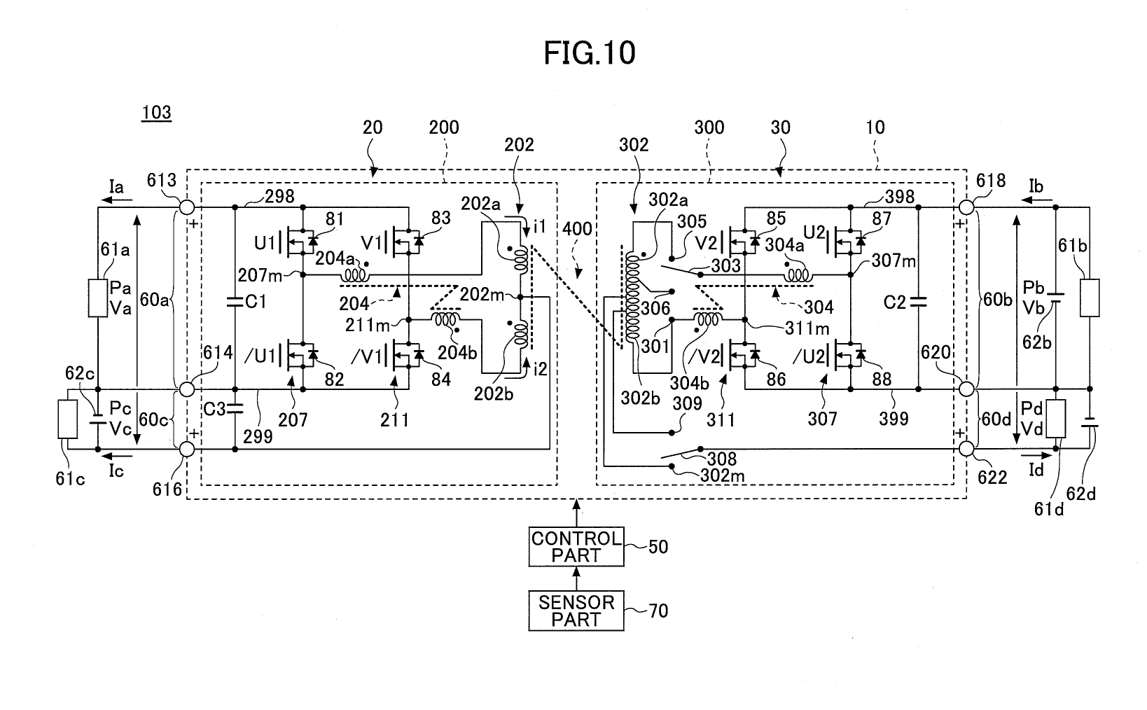

FIG. 10 is a block diagram illustrating a configuration example of a power supply apparatus 103 as yet another embodiment of a power conversion apparatus. The duplicate description of the same configuration and advantageous effects as those of the above-described configuration examples will be omitted.

In the case of FIG. 10, the power supply apparatus 103 has, as secondary-side ports, a third input/output port 60b to which a secondary-side high-voltage-system load 61b and a main battery (i.e., a propulsion battery or a traction battery) 62b are connected and a fourth input/output port 60d to which a secondary-side low-voltage-system load 61d and a secondary-side low-voltage-system power source 62d are connected, for example. The main battery 62b supplies electric power stepped down by a secondary-side conversion circuit 30 included in a power supply circuit 10 to the secondary-side low-voltage-system load 61d driven by a voltage system (for example, a 72 V system lower in voltage than a 288 V system) different from the main battery 62b.

The secondary-side low-voltage-system power source 62d supplies electric power to the secondary-side low-voltage-system load 61d driven by the same voltage system (for example, the 72 V system) as the secondary-side low-voltage-system power source 62d. The secondary-side low-voltage-system power source 62d also supplies electric power, boosted by the secondary-side conversion circuit 30 included in the power supply circuit 10, to, for example, the secondary-side high-voltage-system load 61b driven by the voltage system (for example, the 288 V system) higher in voltage than the secondary-side low-voltage-system power source 62d. As a specific example of the secondary-side low-voltage-system power source 62d, a solar power source (i.e., a solar generator), a AC-DC converter that converts commercial AC power to DC power, a secondary battery or the like can be cited.

The power supply circuit 10 has the above-mentioned four input/output ports, and any two input/output ports are selected from among the four input/output ports. The power supply circuit 10 is an electric power conversion apparatus that carries out electric power conversion between the thus selected two input/output ports.

The secondary-side conversion circuit 30 is a secondary-side circuit including a secondary-side full bridge circuit 300, the third input/output port 60b and the fourth input/output port 60d. The secondary-side full bridge circuit 300 is provided at the secondary side of a transformer 400. The secondary-side full bridge circuit 300 is a secondary-side power conversion part including the secondary coil 302 of the transformer 400, secondary-side magnetic coupling reactors 304, a secondary-side first upper arm U2, a secondary-side first lower arm /U2, a secondary-side second upper arm V2 and a secondary-side second lower arm /V2.

The secondary-side full bridge circuit 300 has a secondary-side positive bus 398 connected to a high-potential-side terminal 618 of the third input/output port 60b and a secondary-side negative bus 399 connected to a low-potential-side terminal 620 of the third input/output port 60b and the fourth input/output port 60d.

In a bridge part connecting a midpoint 307m of a secondary-side first arm circuit 307 and a midpoint 311m of a secondary-side second arm circuit 311, the secondary coil 302 and the secondary-side magnetic coupling reactors 304 are provided. In more detail of connection relationships in the bridge part, one end of a secondary-side first reactor 304a of the secondary-side magnetic coupling reactors 304 is connected to the midpoint 307m of the secondary-side first arm circuit 307. To the other end of the secondary-side first reactor 304a, a tap 305 provided at one end of the secondary coil 302 or a tap 306 provided between the one end and the other end of the secondary coil 302 is selectively connected via a switch 303. Also, to a tap 301 provided at the other end of the secondary coil 302, one end of a secondary-side second reactor 304b of the secondary-side magnetic coupling reactors 304 is connected. Further, the other end of the secondary-side second reactor 304b is connected to the midpoint 311m of the secondary-side second arm circuit 311. Note that the secondary-side magnetic coupling reactors 304 include the secondary-side first reactor 304a, and the secondary-side second reactor 304b magnetically connected to the secondary-side first reactor 304a with a coupling coefficient k₂.

The fourth input/output port 60d is connected to a center tap 302m at the secondary side of the transformer 400, and is a port provided between the secondary-side negative bus 399 and the center tap 302m of the secondary coil 302. The fourth input/output port 60d includes the terminals 620 and 622.

The center tap 302m is connected to the high-potential-side terminal 622 of the fourth input/output port 60d. The center tap 302m is a mid connection point between a first secondary winding 302a and a second secondary winding 302b of the secondary coil 302.

The midpoint 307m and the midpoint 311m are connected via the winding of the secondary coil 302, and the winding of the secondary coil 302 is separated into the first secondary winding 302a and the second secondary winding 302b by the center tap 302m. The secondary coil 302 has the center tap 302m drawn out from the mid connection point between the first secondary winding 302a and the second secondary winding 302b. The number of turns of the first secondary winding 302a is equal to the number of turns of the second secondary winding 302b. The second secondary winding 302b has a tap 309 drawn out between the center tap 302m and the other end of the secondary coil 302.

It is possible to provide a switch 308 in the power supply apparatus 103. The switch 308 is one example of a switching circuit that switches the connecting destination of the port 60d between the center tap 302m and the tap 309. As a specific example of the switch 308, it is possible to cite, as same as the switch 303, a relay, a rotary switch, a slider switch or so. When the switch 303 switches the connecting destination of the midpoint 307m from the tap 305 to the tap 306, the switch 308 switches the connecting destination of the port 60d from the center tap 302m to the tap 309. Thereby, it is possible to use the tap 309 as a center tap. In contrast thereto, when the switch 303 switches the connecting destination of the midpoint 307m from the tap 306 to the tap 305, the switch 308 switches the connecting destination of the port 60d from the tap 309 to the center tap 302m. It is possible that the switching operations of the switch 308 are controlled by the control part 50.

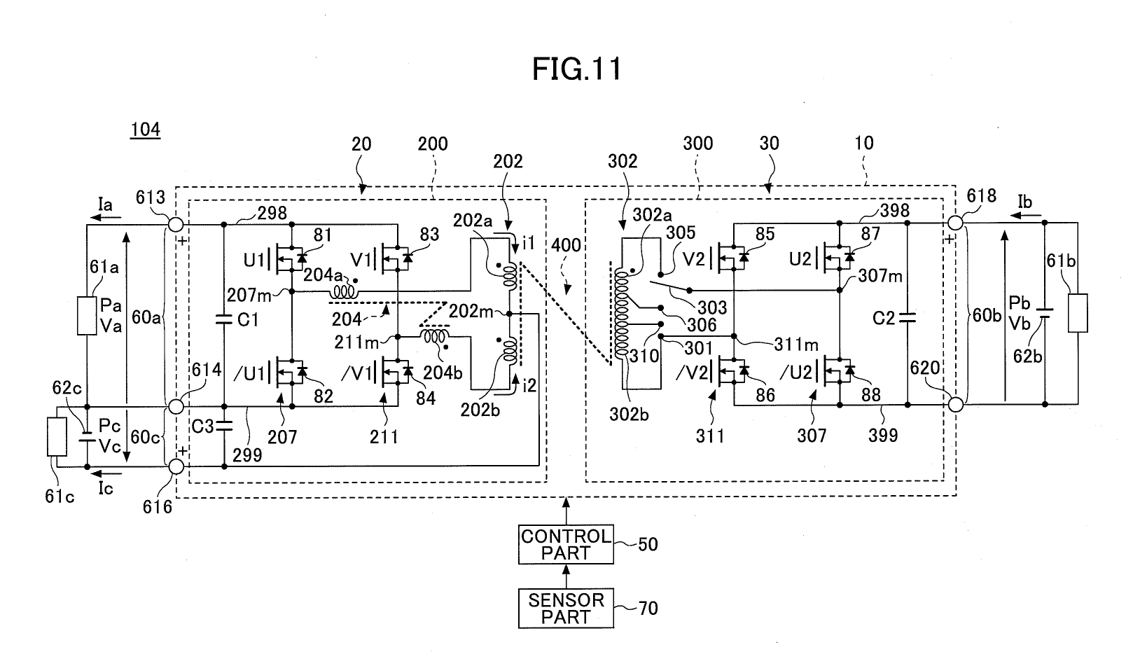

FIG. 11 is a block diagram illustrating a configuration example of a power supply apparatus 104 as another embodiment of a power conversion apparatus. The duplicate description of the same configuration and advantageous effects as those of the above-described configuration examples will be omitted.

As shown in FIG. 11, it is possible that the switch 303 changes the winding turn ratio N by selecting the connecting destination of the midpoint 307m from among three or more taps of the secondary coil 302 (FIG. 11 illustrates three taps 305, 306 and 310). Thereby, it is possible to improve the control resolution of the winding turn ratio N. Thus, it is possible to control the transmission power P more precisely even when the voltage ratio between the port voltage Va and the port voltage Vb varies.

According to the embodiments described above, it is possible to provide electric power conversion apparatuses and methods of controlling the same by which it is possible to transmit sufficient electric power between the primary-side full bridge circuit and the secondary-side full bridge circuit even when the voltage ratio between respective portions of the primary side and the secondary side varies.

Thus, the electric power conversion apparatuses and the methods of controlling the same have been described in the embodiments. However, the present invention is not limited to a specific embodiment, and variations, modifications and/or replacements such as a partial or complete combination or replacement with another embodiment can be made within the scope of the present invention.

For example, in the above-described embodiments, the power MOSFETs that are semiconductor devices performing turning-on/off operations are cited as the switching devices. However, as the switching devices, it is also possible to use voltage-controlled power devices using insulated gates such as IGBTs, MOSFETs or so, or bipolar transistors, instead.

Further, it is possible to provide a power source connectable to the first input/output port 60a. Also, in FIG. 10, it is also possible to provide no power source connectable to the third input/output port 60b and provide a power source connectable to the fourth input/output port 60d.

Further, in the above description, it is possible to define the primary side as a secondary side and define the secondary side as a primary side.

Further, it is possible to provide a circuit switching the number of turns between the respective midpoints of the two arm circuits to each of both the primary side and the secondary side. Also, it is possible that the switching circuit switches the number of turns in a method different from the method of switching the tap in the above-described embodiments. Also, it is possible to provide such a configuration that the switching circuit selects the respective connecting destinations of both the midpoint 307m and the midpoint 311m, separately, from among the taps of the secondary coil.

Further, in the case of FIG. 9, because the number of taps able to be used for the switching is two, the two arm circuit parts are provided in parallel. However, if the number of taps able to be used for the switching is three, it is possible to provide three arm circuit parts in parallel. In other words, it is possible to provide the same number of arm circuit parts as the number of the taps able to be used for the switching in parallel.

The present application is based on and claims the benefit of priority of Japanese Priority Application No. 2014-081404, filed on Apr. 10, 2014, the entire contents of which are hereby incorporated herein by reference.

What is claimed is:

1. An electric power conversion apparatus comprising:
a transformer having a primary coil and a secondary coil;
a primary-side full bridge circuit having a first arm circuit and a second arm circuit in parallel, a first midpoint of the first arm circuit and a second midpoint of the second arm circuit being connected via a winding of the primary coil;
a secondary-side full bridge circuit having a third arm circuit and a fourth arm circuit in parallel, a third midpoint of the third arm circuit and a fourth midpoint of the fourth arm circuit being connected via a winding of the secondary coil;
a switching circuit configured to switch a number of turns of the winding of the secondary coil between the third midpoint and the fourth midpoint; and
a control part configured to control transmission power transmitted between the primary-side full bridge circuit and the secondary-side full bridge circuit by adjusting a first phase difference between switching in the first arm circuit and switching in the third arm circuit and a second phase difference between switching in the second arm circuit and switching in the fourth arm circuit.

2. The electric power conversion apparatus as claimed in claim 1, wherein
the switching circuit is configured to select a connecting destination to connect the third midpoint from among a plurality of taps of the secondary coil.

3. The electric power conversion apparatus as claimed in claim 1, wherein
the switching circuit is configured to connect the third midpoint to another tap of the secondary coil after cutting a connection between the third midpoint and one tap of the secondary coil.

4. The electric power conversion apparatus as claimed in claim 2, wherein
the switching circuit is configured to connect the third midpoint to another tap of the secondary coil after cutting a connection between the third midpoint and one tap of the secondary coil.

5. The electric power conversion apparatus as claimed in claim 1, wherein
the third arm circuit has, in parallel, a first arm circuit part having a midpoint connected to one tap of the secondary coil and a second arm circuit part having a midpoint connected to another tap of the secondary coil,
the first arm circuit part has, on a high side and a low side, pairs of switching devices, each pair of switching devices being connected in parallel,
the second arm circuit part has, on a high side and a low side, pairs of switching devices, each pair of switching devices being connected in parallel, and
the first arm circuit part and the second arm circuit part selectively function as the switching circuit.

6. The electric power conversion apparatus as claimed in claim 2, wherein
the third arm circuit has, in parallel, a first arm circuit part having a midpoint connected to one tap of the secondary coil and a second arm circuit part having a midpoint connected to another tap of the secondary coil,
the first arm circuit part has, on a high side and a low side, pairs of switching devices, each pair of switching devices being connected in parallel,
the second arm circuit part has, on a high side and a low side, pairs of switching devices, each pair of switching devices being connected in parallel, and
the first arm circuit part and the second arm circuit part selectively function as the switching circuit.

7. The electric power conversion apparatus as claimed in claim 1, wherein
the third arm circuit has, in parallel, a first arm circuit part having a midpoint connected to one tap of the secondary coil and a second arm circuit part having a midpoint connected to another tap of the secondary coil, and
the control part is configured to adjust the first phase difference through switching of the first arm circuit part when the second arm circuit part functioning as the switching circuit is turned off, and adjust the first phase difference through switching of the second arm circuit part when the first arm circuit part functioning as the switching circuit is turned off.

8. The electric power conversion apparatus as claimed in claim 2, wherein
the third arm circuit has, in parallel, a first arm circuit part having a midpoint connected to one tap of the secondary coil and a second arm circuit part having a midpoint connected to another tap of the secondary coil, and
the control part is configured to adjust the first phase difference through switching of the first arm circuit part when the second arm circuit part functioning as the switching circuit is turned off, and adjust the first phase difference through switching of the second arm circuit part when the first arm circuit part functioning as the switching circuit is turned off.

9. The electric power conversion apparatus as claimed in claim 5, wherein
the control part is configured to adjust the first phase difference through switching of the first arm circuit part when the second arm circuit part functioning as the switching circuit is turned off, and adjust the first phase difference through switching of the second arm circuit part when the first arm circuit part functioning as the switching circuit is turned off.

10. The electric power conversion apparatus as claimed in claim 6, wherein
the control part is configured to adjust the first phase difference through switching of the first arm circuit part when the second arm circuit part functioning as the switching circuit is turned off, and adjust the first phase difference through switching of the second arm circuit part when the first arm circuit part functioning as the switching circuit is turned off.

11. The electric power conversion apparatus as claimed in claim 1, wherein
the switching circuit is configured to switch the number of turns according to the transmittable transmission power.

12. The electric power conversion apparatus as claimed in claim 11, wherein
the switching circuit is configured to reduce the number of turns when the transmittable transmission power is less than required power.

13. The electric power conversion apparatus as claimed in claim 1 wherein
the switching circuit is configured to switch the number of turns according to a voltage between both ends of the secondary-side full bridge circuit.

14. The electric power conversion apparatus as claimed in claim 13, wherein
the switching circuit is configured to reduce the number of turns when the voltage between both ends of the secondary-side full bridge circuit is less than a threshold.

15. The electric power conversion apparatus as claimed in claim 1, wherein
the switching circuit is configured to switch the number of turns according to a voltage ratio between a voltage between both ends of the primary-side full bridge circuit and a voltage between both ends of the secondary-side full bridge circuit.

16. The electric power conversion apparatus as claimed in claim 15, wherein
the switching circuit is configured to reduce the number of turns when the voltage ratio is less than a winding turn ratio between the primary coil and the secondary coil.

17. The electric power conversion apparatus as claimed in claim 1, wherein
the switching circuit is configured to switch the number of turns in a state where the first arm circuit and the second arm circuit carry out switching in phase and the third arm circuit and the fourth arm circuit are turned off.

18. A method of controlling an electric power conversion apparatus which includes a transformer having a primary coil and a secondary coil, a primary-side full bridge circuit having a first arm circuit and a second arm circuit in parallel, a first midpoint of the first arm circuit and a second midpoint of the second arm circuit being connected via a winding of the primary coil, and a secondary-side full bridge circuit having a third arm circuit and a fourth arm circuit in parallel, a third midpoint of the third arm circuit and a fourth midpoint of the fourth arm circuit being connected via a winding of the secondary coil, the method comprising:
controlling transmission power transmitted between the primary-side full bridge circuit and the secondary-side full bridge circuit by adjusting a first phase difference between switching in the first arm circuit and switching in the third arm circuit and a second phase difference between switching in the second arm circuit and switching in the fourth arm circuit after switching a number of turns of the winding of the secondary coil between the third midpoint and the fourth midpoint.
